(19) United States
(12) Patent Application Publication
(10) Pub. No.: US 2024/0045721 A1
(43) Pub. Date: Feb. 8, 2024

(54) SYSTEMS AND METHODS FOR SOLUTION PROPOSAL WORKFLOW

(71) Applicant: Palantir Technologies Inc., Denver, CO (US)

(72) Inventors: Edward Hall, London (GB); Tomasz Musielak, London (GB); Wojciech Kruk, Lesser Poland (PL)

(21) Appl. No.: 18/228,836

(22) Filed: Aug. 1, 2023

Related U.S. Application Data
(60) Provisional application No. 63/394,414, filed on Aug. 2, 2022.

(51) Int. Cl. G06F 9/50

(52) U.S. Cl. CPC G06F 9/5027

(57) ABSTRACT

System and method for solution proposal workflow according to certain embodiments. For example, a method includes: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; and presenting the one or more selected solutions.

### CROSS REFERENCE TO RELATED APPLICATIONS

This application claims priority to U.S. Provisional Application No. 63/394,414, filed Aug. 2, 2022, which is incorporated by reference herein for all purposes.

### TECHNICAL FIELD

Certain embodiments of the present disclosure are directed to systems and methods for generating and managing software solutions. More particularly, some embodiments of the present disclosure provide systems and methods for generating and managing software solutions in response to alerts.

### BACKGROUND

In certain embodiments, software solutions, which are solutions implemented using software and/or software systems, are used widely in different industries to solve issues and problems. For example, to resolve a low inventory issue of a product for a store, a user may initiate orders via a software solution to purchase the product.

Hence it is desirable to improve the techniques for generating and managing software solutions.

### SUMMARY

Certain embodiments of the present disclosure are directed to systems and methods for generating data pipelines and/or generating descriptions of data pipelines. More particularly, some embodiments of the present disclosure provide systems and methods for generating data pipelines using natural language queries and/or describing data pipelines using natural language.

In some embodiments, a method for solution proposals, the method includes the steps of: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; and presenting the one or more selected solutions; wherein the method is performed using one or more processors.

In certain embodiments, a computing system for solution proposals, the computing system comprising: one or more memories storing instructions thereon; and one or more processors configured to execute the instructions and perform operations comprising: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; and presenting the one or more selected solutions.

In some embodiments, a method for solution proposals, the method comprising: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; determining one or more performance indicators, each performance indicator of the one or more performance indicators being associated with one selected solution of the one or more selected solutions; and presenting the one or more selected solutions with the one or more performance indicators; wherein the method is performed using one or more processors.

Depending upon embodiments, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is a simplified diagram showing a method for solutions proposal workflow according to certain embodiments of the present disclosure.

FIG. 2 is a simplified diagram showing a computing system for implementing a system for solutions proposal workflow according to some embodiments of the present disclosure.

FIG. 3 is a simplified diagram showing a method for solution proposals according to certain embodiments of the present disclosure.

FIG. 4 is an illustrative example of a solution proposal workflow environment, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to certain embodiments, the solutions proposal workflow allows one or more users to create (e.g., using a point and click interface) one or more predetermined solutions (e.g., software solutions) to problems which can then be stored as “what-if” scenarios, interacting with the one or more users' data asset and models to simulate impact. For example, when a problem is identified (e.g., either by alerting or user input), the system and/or the method traverses the approved solution space provided for valid solutions, removes invalid solutions and displays any corresponding key performance indicators (KPIs). As an example, one or more operational decision makers can then view these scenarios and key performance indicators (e.g., presented in one or more charts), assign them to relevant stakeholders across the business for approval and eventual actioning.

According to some embodiments, the solutions proposal workflow is relevant in one or more alerting and/or problem-solving use cases. For example, the solutions proposal workflow uses a rules creator to provide and/or limit the solutions space and also provide one or more scenarios and/or one or more functions and/or ontology to simulate the effect of each of the solutions in the solutions space. In certain embodiments, an ontology refers to a structural framework (e.g., data model) containing information and data related to objects and relationships of objects (e.g., functions applicable to objects, links) within a specific solution space (e.g., a domain, an organization, an industry). In some embodiments, a solution, also referred to as a software solution or an application, includes one or more actions taken on one or more objects or among objects. In certain embodiments, an action refers to one or more processing logics applied to one or more objects including, for example, creating objects, changing objects, combining objects, linking objects, deleting objects, and/or the like. In some embodiments, a scenario, also referred to as a scenario solution or a possible solution, includes one or more objects, one or more actions (e.g., a plurality of actions, a series of actions, actions in sequence and/or in parallel, a pipeline of actions), one or more metrics, and/or one or more constraints. In certain embodiments, a metric indicates a performance indicator of a solution (e.g., a scenario). In some embodiments, a metric object can be generated and used for tracking one or more metrics associated with one or more objects and/or one or more actions. In certain embodiments, an alert includes information about a problem, for example, one or more parameters of a problem.

Certain embodiments of systems and methods for solutions proposal workflow provide one or more following advantages:
A) save time and/or increase accuracy of constructing solutions to problems which are solvable with predetermined solutions. For example, one always tries X and Y first, so solutions for X and Y are generated.
B) limit the solutions space beyond combinations of determined actions. For example, the solutions output from the workflow can act as a limited set of options which are allowed to be carried out. As an example, one is allowed to perform complex validation logic before displaying solutions.
C) allow one to pre-calculate key performance indicators (KPIs) for each solution, so that a user does not have to iterate through all options to see impact, but instead can see ahead of time.

Some embodiments of systems and methods for solutions proposal workflow are used to find an optimal solution of all created solutions using heuristics. For example, the solutions proposal workflow is used to solve an issue of ensuring sufficient inventory at one or more fulfillment centers, but it would be recognized that the solutions proposal workflow has a much broader range of applicability.

In certain embodiments, the solutions proposal workflow includes the following processes:
Process 1: Alerting (e.g., creating alerts)
Process 2: Scenarios (e.g., allowing one or more users to create scenarios as a “branched” version of the ontology using actions)
Process 3: Metrics (e.g., computing on-the-fly metrics of how user actions impact key performance indicators)
Process 4: Suggestions (e.g., pre-computing one or more solutions based on predetermined rules confined within the rails of actions)
   Although the above has been shown using a selected group of processes for the solutions proposal workflow, there can be many alternatives, modifications, and variations. For example, some of the processes may be expanded and/or combined. Other processes may be inserted to those noted above. Depending upon the embodiment, the sequence of processes may be interchanged with others replaced.

In some examples, at process 1 (e.g., alerting), leveraging an ontology, one can use “metrics” of an object to do alerting. For example, the days of coverage of a site-sku can be stored in the metrics object. As an example, the primary key (PK) of the alert is the site_sku_id, but the starting object is the metric object. For example, the same metrics are used by an inventory planner later to determine if the scenario that has been created works. As an example, the same metrics are used in both situations, but one is pre-calculated and the other is on the fly. For example, some metrics are predetermined and some metrics can be dynamically changed.

In certain examples, at process 2 (e.g., scenarios), a combination of scenarios, actions and/or FoO (on the fly) is used to allow one or more inventory planners to create one or more solutions to solve each alert. For example, the solutions proposal workflow involves creating a staged scenario, creating a combination of one or more transfer orders (e.g., transfer order solutions) from one or more internal plants and/or one or more purchase orders (e.g., purchase order solutions) from one or more vendors, and seeing how this impacts the key performance indicators (KPIs) onscreen. As an example, once a planner is happy with their scenario, the scenario (e.g., the solution) is saved as an object and the responsibility is assigned to someone on the logistics team. For example, the saved scenario and/or the assignment of responsibility then acts as a set of instructions for someone on the logistics team to carry out. As an example, the logistics team approve, reject, edit and/or re-assign the scenario.

As an example, all actions in the scenario are on the true ontology object types but need not be committed to the true ontology (e.g., thus acting as a branch). For example, one can use the key performance indicators (KPIs) provided on the actual transfer order objects in both the scenario and in the real ontology.

In some examples, at process 3 (e.g., metrics), “metrics” are provided as a way to generate alerts and/or to measure the performance of a solution (e.g., scenario). For example, a metric is “days of coverage,” which is determined on both a plant-material level and rolls up to aggregate levels (e.g., region). As an example, this metric is determined twice, once to create an alert and then again on the fly to live-display the impact of a user scenario on the days of coverage. For example, there are other ways of doing this that do not involve determining the metric twice, and rather only determine it once and share the determination for both alerting and on-the-fly live displaying of the impact.

In certain examples, at process 4 (e.g., suggestions), many of a planner's actions are pre-programmed. For example, if a user is short of material but has the material in the user's network, then the user transfers the material; the user does not need to buy more material—the user can instead execute a transfer to solve the problem. As an example, the present disclosure provides, among other things, a configurable way for one or more users to create “logical flows” of automatic decision making (e.g., if this then that). For example, the solutions proposal workflow involves going from object to actions. As an example, two actions—“Create Transfer Order” and “Create Purchase Order”—are provided (e.g., via two corresponding solutions), and one can then create logic starting with alerts and can solve these alerts using these actions. For example, two datasets are derived, one for each action. As an example, one can then use an input manager to make API (application programming interface) calls to the scenarios service to pre-create scenarios and then create an output dataset of a transform which then acts as the base dataset for saved scenarios. For example, a user can see any pre-created scenarios for each alert on how the alert can be solved. As an example, the user then can approve, edit or reject.

In some embodiments, any difference between what an administrator proposes, what a user selects, and/or what actually happens is tracked. For example, such differences can be used (e.g., by a machine learning model) to improve the systems and methods for the solutions proposal workflow going forward.

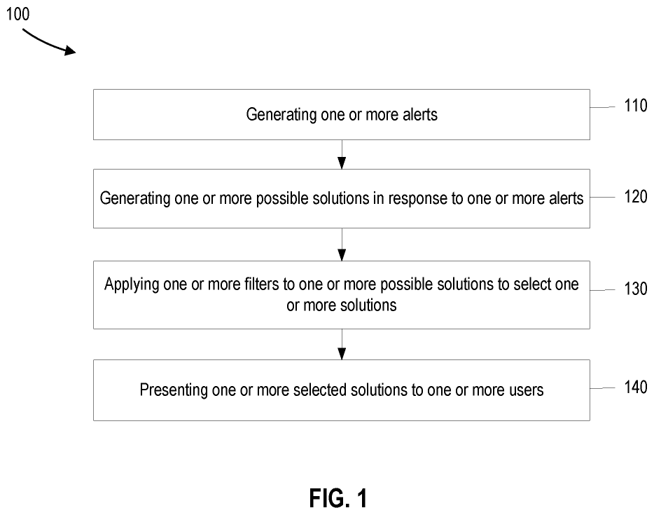

FIG. 1 is a simplified diagram showing a method for solutions proposal workflow according to certain embodiments of the present disclosure. This diagram is merely an example. One of ordinary skill in the art would recognize many variations, alternatives, and modifications. The method 100 includes processes 110, 120, 130 and 140 that are performed using one or more processors. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced.

In some embodiments, some or all processes (e.g., steps) of the method 100 are performed by a system (e.g., the computing system 600). In certain examples, some or all processes (e.g., steps) of the method 100 are performed by a computer and/or a processor directed by a code. For example, a computer includes a server computer and/or a client computer (e.g., a personal computer). In some examples, some or all processes (e.g., steps) of the method 100 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

In certain embodiments, at the process 110, one or more alerts are generated. For example, the one or more alerts are generated based at least in part on one or more predetermined metrics. As an example, the one or more alerts correspond to one or more problems that need to be solved.

In some embodiments, at the process 120, one or more possible solutions are generated in response to the one or more alerts. For example, the one or more possible solutions are generated in a predetermined solution space with one or more predetermined rules and/or one or more limitations. As an example, the one or more possible solutions represent one or more scenarios in which the one or more problems may or may not be solved in a way that is satisfactory to one or more users.

In certain embodiments, at the process 130, one or more filters are applied to the one or more possible solutions to select one or more solutions from the one or more possible solutions. For example, the one or more selected solutions represent one or more scenarios in which the one or more problems can be solved in a way that is satisfactory to the one or more users. As an example, the one or more selected solutions are one or more validated solutions.

In some embodiments, at the process 140, the one or more selected solutions are presented to the one or more users. For example, for each selected solution, one or more key performance indicators for the solution are also provided. As an example, the one or more users choose one solution from the one or more selected solutions and then send the chosen solution for approval and/or implementation.

As indicated above and further emphasized here, FIG. 1 is merely an example. One of ordinary skill in the art would recognize many variations, alternatives, and modifications. For example, at the process 140, one solution is automatically chosen from the one or more selected solutions based at least in part on one or more key performance indicators for each selected solution, without presenting the one or more selected solutions to the one or more users. As an example, at the process 140, the chosen solution is automatically implemented without being sent for approval.

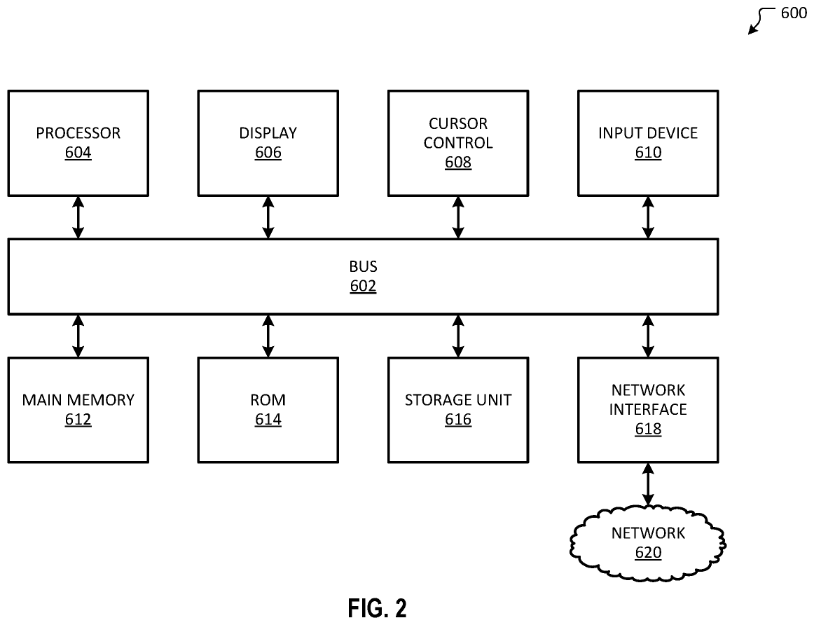

FIG. 2 is a simplified diagram showing a computing system for implementing a system for solutions proposal workflow according to some embodiments of the present disclosure. This diagram is merely an example. One of ordinary skill in the art would recognize many variations, alternatives, and modifications. The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In certain embodiments, some or all processes (e.g., steps) of the methods 100, 300, and/or 400 are performed by the computing system 600. In some examples, the bus 602 is coupled to the processor 604, the display 606, the cursor control component 606, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For example, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control 608 (e.g., a mouse, a trackball, or cursor direction keys) is configured to communicate additional information and commands (e.g., to control cursor movements on the display 606) to the processor 604.

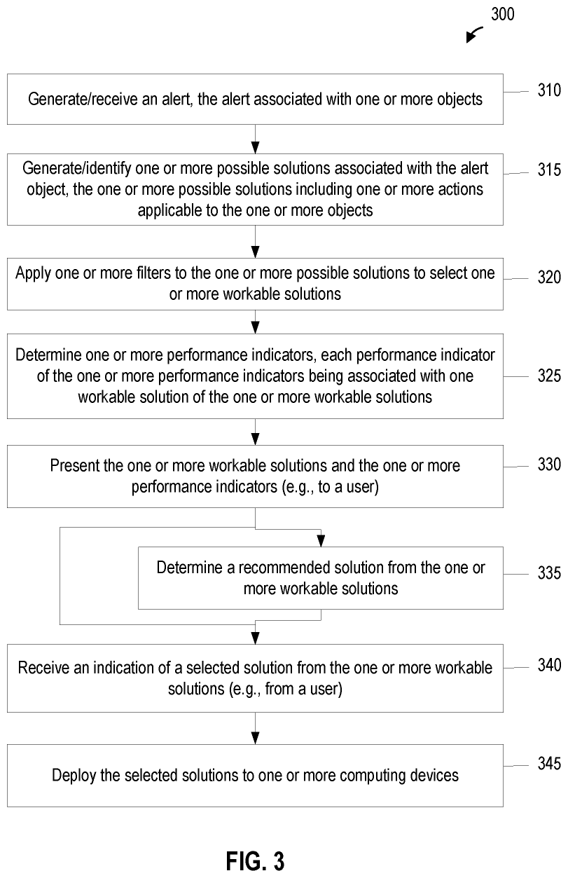

FIG. 3 is a simplified diagram showing a method 300 for solution proposals according to certain embodiments of the present disclosure. This diagram is merely an example. One of ordinary skill in the art would recognize many variations, alternatives, and modifications. The method 300 for solution proposals includes processes 310, 315, 320, 325, 330, 335, 340, and 345. Although the above has been shown using a selected group of processes for the method 300 for solution proposals, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 300 are performed by a system (e.g., the computing system 600). In certain examples, some or all processes (e.g., steps) of the method 300 are performed by a computer and/or a processor directed by a code. For example, a computer includes a server computer and/or a client computer (e.g., a personal computer). In some examples, some or all processes (e.g., steps) of the method 300 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to certain embodiments, at process 310, a system (e.g., a solution proposal system, a solution proposal workflow) generates and/or receives an alert, for example, identifying a problem. In some embodiments, the alert is received from a user device. In certain embodiments, an alert refers to an alert object configured to monitor operation environments and generate alerts (e.g., inventory low). In some embodiments, an alert includes information about a problem, for example, one or more parameters of a problem. For example, an alert includes an indication of a product being out of stock. As an example, an alert includes an inventory alert providing a list of products low in inventory. In certain embodiments, an alert includes a set of alerts that can be filtered. In some embodiments, an alert includes a set of alerts that can be filtered by roles (e.g., a store manager, a distribution center manager, etc.). In certain embodiments, an alert includes a sequence of alerts related to a same problem. In some examples, an alert includes recurring alerts.

In certain embodiments, the identified problem is associated with one or more objects. For example, a problem of Product X is out of stock at Store Y, includes the objects of Product X and Store Y. In some embodiments, the alert is associated with one or more objects. In certain embodiments, the alert includes one or more metrics (e.g., a threshold inventory) associated with one or more objects. In certain embodiments, the alert (e.g., the alert object) includes a metric object associated with an object. As an example, the alert includes the inventory metric object of Product X. In certain examples, an alert is used to generate a plurality of actions (e.g., a series of actions, one or more actions to be run in parallel and/or in sequence) in a solution. In some embodiments, the alert includes a metric that is predetermined (e.g., an inventor threshold of a predetermined level). In certain embodiments, the alert includes a metric that is dynamically changed in the solution space (e.g., as a function of an input).

According to some embodiments, at process 315, the system generates and/or identifies one or more possible solutions associated with the alert, where the one or more possible solutions include one or more actions applicable to the one or more objects. In certain embodiments, at least one of the one or more possible solutions can be used to solve the problem. In some embodiments, at least one of the one or more possible solutions does not solve the problem or cannot be used to solve the problem. In some embodiments, at least one of or all of the one or more possible solutions are retrieved from a data repository. In certain embodiments, at least one of or all of the one or more possible solutions are programmatically (e.g., automatically) generated. In certain embodiments, a possible solution includes one or more actions to be applied to objects. In some embodiments, the one or more actions includes a sequence of actions. For example, the one or more actions includes a first action to be taken before a second action.

In some embodiments, the one or more possible solutions are programmatically generated based on a set of predetermined rules. In some examples, one or more possible solutions can be manually generated or modified by users (e.g., power users, users with certain administrative rights). In certain examples, power users refer to a set of users who can create solutions and change rules. In some examples, operation users refer to a set of users who cannot create solutions or change rules used in the solution space but can select and use solutions. In certain examples, one or more possible solutions can be populated into one or more solution spaces. For example, the alert is inventory low, and the possible solutions include different purchase order solutions and/or transfer order solutions (e.g., transfer from other plants) implemented programmatically. In some embodiments, the alert includes a set of alerts that is filtered into two or more subsets of alerts, and two or more sets of possible solutions are generated (e.g., selected, identified) associated with the two or more subsets of alerts. In certain embodiments, the two or more sets of possible solutions include a first set of possible solutions and a second set of possible solutions, where the first set of possible solutions includes at least a possible solution not in the second set of possible solutions.

According to certain embodiments, at process 320, the system applies one or more filters to the one or more possible solutions to select one or more filtered solutions (e.g., one or more workable solutions), also referred to as a subset of solutions. In some embodiments, a filter reflects a rule, also referred to a criterion, for example, a criterion indicating a condition to be satisfied, a criterion indicating a range of a parameter, a criterion indicating a threshold, a criterion indicating one or more options, a criterion indicating a constraint, and/or the like. In certain embodiments, the filters and/or the rules can be set by a subset of users (e.g., power users, users with adequate rights). In some embodiments, a subset of users (e.g., operation users) cannot add, change, and/or delete the filter and/or the rule. For example, for an inventory low alert, the filter includes a criterion of geography area, such that the purchase order solutions in the geography area can be selected using the filter. As another example, for an inventory low alert, the filter includes a criterion of acceptable delivery dates, such that the purchase order solutions meeting the acceptable deliverable dates can be selected using the filter. In some embodiments, the one or more filters use the at least one metric of the one or more metrics associated with the alert.

According to certain embodiments, at process 325, the system determines one or more performance indicators (e.g., KPIs, costs, speeds, timing, feasibilities, efficiencies, etc.), where each performance indicator of the one or more performance indicators is associated with one workable solution of the one or more workable solutions. In some embodiments, the performance indicators are associated with the solution space (e.g., the solution domain, the supply chain domain, the manufacturing domain, etc.). For example, the performance indicator for a supply chain domain includes the cost, transit time, and/or the like. In certain embodiments, a performance indicator includes a function of a parameter (e.g., a parameter in domain). In some embodiments, the performance indicators are associated with the metrics corresponding to the alert (e.g., alert object). In some embodiments, the performance indicator is associated with a metric that is predetermined (e.g., an inventor threshold of a predetermined level). In certain embodiments, the performance indicator is associated with a metric that is dynamically changed in the solution space (e.g., as a function of an input). In some embodiments, the system determines one or more performance indicators for each of the one or more possible solutions.

According to certain embodiments, at process 330, the system presents one or more workable solutions (e.g., scenarios, scenarios with scenario identifiers (IDs)) and the one or more performance indicators, for example, to a user. In some embodiments, a workable solution is associated with two or more performance indicators. In certain embodiments, the system can rank the one or more selected solutions using the one or more performance indicators. In some embodiments, the system can determine a solution score for a selected solution using the one or more performance indicators. In certain embodiments, at process 335, the system can determine a recommended solution from the one or more workable solutions. For example, the system can determine a recommended solution to be the solution with the highest rank and/or the highest solution score (e.g., best performance). In some embodiments, the system can present the recommended solution to the user. In certain embodiments, the system may not determine a recommended solution and receives user input for a selected solution.

In some examples, the system can combine KPIs and one or more possible solutions to create the scenario presentation (e.g., presented in a user interface). In certain examples, the system provides the possible solutions (e.g., scenarios) to users, saves the possible solutions (e.g., scenarios as objects) and/or present the possible solutions in different solution spaces (e.g., applications).

According to some embodiments, at process 340, the system receives an indication of a selected solution (e.g., a designated solution) from the one or more workable solutions, for example, from a user or a user device. In some embodiments, the indication of the selected solution is received via a software interface. In certain embodiments, a software interface includes an application programming interface (API), a web service interface, retrieving information from a file, retrieving information from a data repository, and/or the like. In some embodiments, the indication of the selected solution includes an indication of approval or disapproval to the recommended solution. In certain embodiments, at process 345, the system deploys the selected solution to one or more computing devices (e.g., user devices).

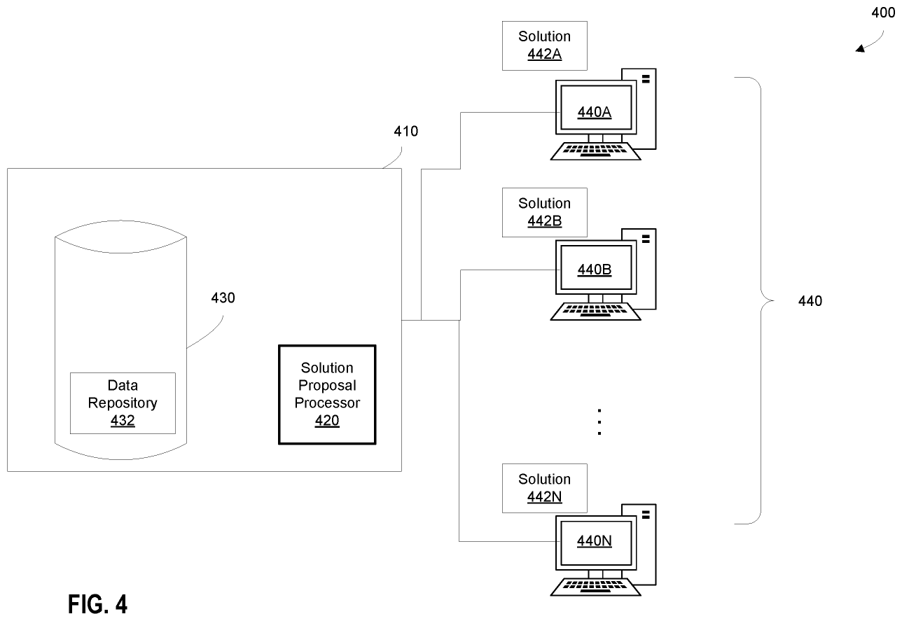

FIG. 4 is an illustrative example of a solution proposal workflow environment 400, according to certain embodiments of the present disclosure. FIG. 4 is merely an example. One of the ordinary skilled in the art would recognize many variations, alternatives, and modifications. According to certain embodiments, the solution proposal workflow environment 400 includes a solution proposal system 410 and one or more computing devices 440 (e.g., computing device 440A, computing device 440B, . . . , computing device 440N). In some embodiments, the solution proposal system 410 includes a solution proposal processor 420, one or more repositories 430 including one or more data repositories 432. In certain embodiments, one or more components of the solution proposal system 410 are included in the one or more computing devices 440. For example, the computing device 440 can access the repository 430. In some embodiments, the computing devices 440 include corresponding solutions 442 (e.g., solution 442A, solution 442B, . . . , solution 442N) running on the computing device 440.

Although the above has been shown using a selected group of components in the solution proposal workflow environment 400, there can be many alternatives, modifications, and variations. For example, some of the components may be expanded and/or combined. Other components may be inserted into those noted above. Depending upon the embodiment, the arrangement of components may be interchanged with others replaced. Further details of these components are found throughout the present disclosure.

According to certain embodiments, the solution proposal system 410 and/or the solution proposal processor 420 generates and/or receives an alert, for example, identifying a problem. In some examples, the alert is received from a computing device 440. In some embodiments, the alert is received from a user device. In certain embodiments, an alert refers to an alert object configured to monitor operation environments and generate alerts (e.g., inventory low). In some embodiments, an alert includes information about a problem, for example, one or more parameters of a problem. For example, an alert includes an indication of a product being out of stock. As an example, an alert includes an inventory alert providing a list of products low in inventory. In certain embodiments, an alert includes a set of alerts that can be filtered. In some embodiments, an alert includes a set of alerts that can be filtered by roles (e.g., a store manager, a distribution center manager, etc.). In certain embodiments, an alert includes a sequence of alerts related to a same problem. In some examples, an alert includes recurring alerts.

In certain embodiments, the identified problem is associated with one or more objects. For example, a problem of Product X is out of stock at Store Y, includes the objects of Product X and Store Y. In some embodiments, the alert is associated with one or more objects. In certain embodiments, the alert includes one or more metrics (e.g., a threshold inventory) associated with one or more objects. In certain embodiments, the alert (e.g., the alert object) includes a metric object associated with an object. As an example, the alert includes the inventory metric object of Product X. In certain examples, an alert is used to generate a plurality of actions (e.g., a series of actions, one or more actions to be run in parallel and/or in sequence) in a solution. In some embodiments, the alert includes a metric that is predetermined (e.g., an inventor threshold of a predetermined level). In certain embodiments, the alert includes a metric that is dynamically changed in the solution space (e.g., as a function of an input).

According to some embodiments, the solution proposal system 410 and/or the solution proposal processor 420 generates and/or identifies one or more possible solutions associated with the alert, where the one or more possible solutions include one or more actions applicable to the one or more objects. In certain embodiments, at least one of the one or more possible solutions can be used to solve the problem. In some embodiments, at least one of the one or more possible solutions does not solve the problem or cannot be used to solve the problem. In some embodiments, at least one of or all of the one or more possible solutions are retrieved from the data repository 432. In certain embodiments, at least one of or all of the one or more possible solutions are programmatically (e.g., automatically) generated. In certain embodiments, a possible solution includes one or more actions to be applied to objects. In some embodiments, the one or more actions includes a sequence of actions. For example, the one or more actions includes a first action to be taken before a second action.

In some embodiments, the one or more possible solutions are programmatically generated based on a set of predetermined rules. In some examples, one or more possible solutions can be manually generated or modified by users (e.g., power users, users with certain administrative rights). In certain examples, one or more possible solutions can be populated into one or more solution spaces. For example, the alert is inventory low, and the possible solutions include different purchase order solutions implemented programmatically. In some embodiments, the alert includes a set of alerts that is filtered into two or more subsets of alerts, and two or more sets of possible solutions are generated (e.g., selected, identified) associated with the two or more subsets of alerts. In certain embodiments, the two or more sets of possible solutions include a first set of possible solutions and a second set of possible solutions, where the first set of possible solutions includes at least a possible solution not in the second set of possible solutions.

According to certain embodiments, the solution proposal system 410 and/or the solution proposal processor 420 applies one or more filters to the one or more possible solutions to select one or more filtered solutions (e.g., one or more workable solutions), also referred to as a subset of solutions. In some embodiments, at least one of or all of the one or more filters are retrieved from the repository 430. In some embodiments, a filter is associated with a rule or one or more criteria, for example, a criterion indicating a condition to be satisfied, a criterion indicating a range of a parameter, a criterion indicating a threshold, a criterion indicating one or more options, a criterion indicating a constraint, and/or the like. In certain embodiments, the filters and/or the rules can be set by a subset of users (e.g., power users, users with adequate rights). In some embodiments, a subset of users (e.g., operation users) cannot add, change, and/or delete the filter and/or the rule. For example, for an inventory low alert, the filter includes a criterion of geography area, such that the purchase order solutions in the geography area can be selected using the filter. As another example, for an inventory low alert, the filter includes a criterion of acceptable delivery dates, such that the purchase order solutions meeting the acceptable deliverable dates can be selected using the filter. In some embodiments, the one or more filters use at least one metric of the one or more metrics associated with the alert.

According to certain embodiments, the solution proposal system 410 and/or the solution proposal processor 420 determines one or more performance indicators (e.g., KPIs, costs, speeds, timing, feasibilities, efficiencies, etc.), where each performance indicator of the one or more performance indicators is associated with one filtered solution of the one or more filtered solutions. In some embodiments, the performance indicators are associated with the solution domain (e.g., the supply chain domain, the manufacturing domain, etc.). For example, the performance indicator for a supply chain domain includes the cost, transit time, and/or the like. In certain embodiments, a performance indicator includes a function of a parameter (e.g., a parameter in domain). In some embodiments, the performance indicators are associated with the metrics corresponding to the alert (e.g., alert object). In some embodiments, the performance indicator is associated with a metric that is predetermined (e.g., an inventor threshold of a predetermined level). In certain embodiments, the performance indicator is associated with a metric that is dynamically changed in the solution space (e.g., as a function of an input). In some embodiments, the solution proposal system 410 and/or the solution proposal processor 420 determines one or more performance indicators for each of the one or more possible solutions.

According to certain embodiments, the solution proposal system 410 and/or the solution proposal processor 420 presents one or more workable solutions (e.g., scenarios, scenarios with scenario identifiers (IDs)) and the one or more performance indicators, for example, to a user and/or on a computing device 440. In some embodiments, a workable solution is associated with two or more performance indicators. In certain embodiments, the solution proposal system 410 and/or the solution proposal processor 420 can rank the one or more selected solutions using the one or more performance indicators. In some embodiments, the solution proposal system 410 and/or the solution proposal processor 420 can determine a solution score for a selected solution using the one or more performance indicators. In certain embodiments, the solution proposal system 410 and/or the solution proposal processor 420 can determine a recommended solution from the one or more workable solutions. For example, the solution proposal system 410 and/or the solution proposal processor 420 can determine a recommended solution to be the solution with the highest rank and/or the highest solution score (e.g., best performance). In some embodiments, the solution proposal system 410 and/or the solution proposal processor 420 can present the recommended solution to the user. In certain embodiments, the solution proposal system 410 and/or the solution proposal processor 420 may not determine a recommended solution and receives user input for a selected solution.

In some examples, the solution proposal system 410 and/or the solution proposal processor 420 can combine KPIs and one or more possible solutions to create the scenario presentation (e.g., presented in a user interface). In certain examples, the solution proposal system 410 and/or the solution proposal processor 420 provides the possible solutions (e.g., scenarios) to users, saves the possible solutions (e.g., scenarios as objects) and/or presents the possible solutions in different solution spaces (e.g., applications).

According to some embodiments, the solution proposal system 410 and/or the solution proposal processor 420 receives an indication of a selected solution (e.g., a designated solution) from the one or more workable solutions, for example, from a user or a computing device 440. In some embodiments, the indication of the selected solution is received via a software interface. In certain embodiments, a software interface includes an application programming interface (API), a web service interface, retrieving information from a file, retrieving information from a data repository, and/or the like. In some embodiments, the indication of the selected solution includes an indication of approval or disapproval to the recommended solution. In certain embodiments, the solution proposal system 410 and/or the solution proposal processor 420 deploys the selected solution 442, for example, to one or more computing devices 440.

In some embodiments, the repository 430 can include possible solutions, scenarios, performance indicators, and/or the like. The repository 430 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the solution proposal workflow environment 400 can execute software or firmware stored in non-transitory computer-readable medium to implement various processing steps. Various components and processors of the solution proposal workflow environment 400 can be implemented by one or more computing devices including, but not limited to, circuits, a computer, a cloud-based processing unit, a processor, a processing unit, a microprocessor, a mobile computing device, and/or a tablet computer. In some cases, various components of the solution proposal workflow environment 400 (e.g., the solution proposal system 410, the solution proposal processor 420, the computing device 440) can be implemented on a shared computing device. Alternatively, a component of the solution proposal workflow environment 400 can be implemented on multiple computing devices. In some implementations, various modules and components of the solution proposal workflow environment 400 can be implemented as software, hardware, firmware, or a combination thereof. In some cases, various components of the solution proposal workflow environment 400 can be implemented in software or firmware executed by a computing device.

Various components of the solution proposal workflow environment 400 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

According to certain embodiments, a method for solution proposals, the method includes the steps of: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; and presenting the one or more selected solutions; wherein the method is performed using one or more processors. For example, the method is implemented according to at least FIG. 1, FIG. 3, and/or FIG. 4.

In some embodiments, the method further includes the steps of: determining one or more performance indicators, each performance indicator of the one or more performance indicators being associated with one selected solution of the one or more selected solutions; and presenting the one or more selected solutions with the one or more performance indicators to the user. In certain embodiments, the method further includes the steps of: determining a recommended solution from the one or more selected solutions based at least in part on the one or more performance indicators; and presenting the recommended solution. In some embodiments, the method further includes the steps of: receiving an indication of solution selection; and deploying a solution that is one of the one or more selected solutions based on the indication of solution selection to one or more computing devices.

In certain embodiments, the alert includes one or more metrics associated with the one or more objects, wherein at least one performance indicator of the one or more performance indicators is associated with at least one metric of the one or more metrics. In some embodiments, the filter uses the at least one metric of the one or more metrics. In certain embodiments, at least one metric of the one or more metrics is dynamically changeable. In certain embodiments, the identifying one or more possible solutions comprises generating at least one of the one or more possible solutions. In some embodiments, the alert includes a set of alerts, wherein the method further comprises: filtering the set of alerts to a first subset of alerts and a second subset of alerts; wherein the one or more possible solutions include a first set of possible solutions associated with the first subset of alerts and a second set of possible solutions associated with the second subset of alerts.

According to some embodiments, a computing system for solution proposals, the computing system comprising: one or more memories storing instructions thereon; and one or more processors configured to execute the instructions and perform operations comprising: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; and presenting the one or more selected solutions. For example, the method is implemented according to at least FIG. 1, FIG. 3, and/or FIG. 4.

In some embodiments, the operations further comprise: determining one or more performance indicators, each performance indicator of the one or more performance indicators being associated with one selected solution of the one or more selected solutions; and presenting the one or more selected solutions with the one or more performance indicators to the user. In certain embodiments, the operations further comprise: determining a recommended solution from the one or more selected solutions based at least in part on the one or more performance indicators; and presenting the recommended solution. In some embodiments, the operations further comprise: receiving an indication of solution selection; and deploying a solution that is one of the one or more selected solutions based on the indication of solution selection to one or more computing devices.

In certain embodiments, the alert includes one or more metrics associated with the one or more objects, wherein at least one performance indicator of the one or more performance indicators is associated with at least one metric of the one or more metrics. In some embodiments, the filter uses the at least one metric of the one or more metrics. In certain embodiments, at least one metric of the one or more metrics is dynamically changeable. In certain embodiments, the identifying one or more possible solutions comprises generating at least one of the one or more possible solutions. In some embodiments, the alert includes a set of alerts, wherein the operations further comprise: filtering the set of alerts to a first subset of alerts and a second subset of alerts; wherein the one or more possible solutions include a first set of possible solutions associated with the first subset of alerts and a second set of possible solutions associated with the second subset of alerts.

According to certain embodiments, a method for solution proposals, the method includes the steps of: generating an alert, the alert associated with one or more objects; identifying one or more possible solutions associated with the alert, the one or more possible solutions including one or more actions applicable to the one or more objects; applying a filter to the one or more possible solutions to select one or more solutions from the one or more possible solutions; determining one or more performance indicators, each performance indicator of the one or more performance indicators being associated with one selected solution of the one or more selected solutions; and presenting the one or more selected solutions with the one or more performance indicators; wherein the method is performed using one or more processors. For example, the method is implemented according to at least FIG. 1, FIG. 3, and/or FIG. 4.

In some embodiments, the method further includes the steps of: receiving an indication of solution selection; and deploying a solution that is one of the one or more selected solutions based on the indication of solution selection to one or more computing devices.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A method for solution proposals, the method comprising:
generating an alert, the alert associated with one or more objects;
identifying one or more possible solutions associated with the alert, the one or more possible solutions including one or more actions applicable to the one or more objects;
applying a filter to the one or more possible solutions to select one or more solutions from the one or more possible solutions; and
presenting the one or more selected solutions;
wherein the method is performed using one or more processors.

2. The method of claim 1, further comprising:
determining one or more performance indicators, each performance indicator of the one or more performance indicators being associated with one selected solution of the one or more selected solutions; and
presenting the one or more selected solutions with the one or more performance indicators to the user.

3. The method of claim 2, further comprising:
determining a recommended solution from the one or more selected solutions based at least in part on the one or more performance indicators; and
presenting the recommended solution.

4. The method of claim 2, further comprising:
receiving an indication of solution selection; and
deploying a solution that is one of the one or more selected solutions based on the indication of solution selection to one or more computing devices.

5. The method of claim 2, wherein the alert includes one or more metrics associated with the one or more objects, wherein at least one performance indicator of the one or more performance indicators is associated with at least one metrics of the one or more metrics.

6. The method of claim 5, wherein the filter uses the at least one metric of the one or more metrics.

7. The method of claim 5, wherein at least one metric of the one or more metrics is dynamically changeable.

8. The method of claim 1, wherein the identifying one or more possible solutions comprises generating at least one of the one or more possible solutions.

9. The method of claim 1, wherein the alert includes a set of alerts, wherein the method further comprises:
filtering the set of alerts to a first subset of alerts and a second subset of alerts;
wherein the one or more possible solutions include a first set of possible solutions associated with the first subset of alerts and a second set of possible solutions associated with the second subset of alerts.

10. A computing system for solution proposals, the computing system comprising:
one or more memories storing instructions thereon; and
one or more processors configured to execute the instructions and perform operations comprising:
generating an alert, the alert associated with one or more objects;
identifying one or more possible solutions associated with the alert, the one or more possible solutions including one or more actions applicable to the one or more objects;
applying a filter to the one or more possible solutions to select one or more solutions from the one or more possible solutions; and
presenting the one or more selected solutions.

11. The system of claim 10, wherein the operations further comprise:
determining one or more performance indicators, each performance indicator of the one or more performance indicators being associated with one selected solution of the one or more selected solutions; and
presenting the one or more selected solutions with the one or more performance indicators.

12. The system of claim 11, wherein the operations further comprise:
determining a recommended solution from the one or more selected solutions based at least in part on the one or more performance indicators; and
presenting the recommended solution.

13. The system of claim 11, wherein the operations further comprise:
receiving an indication of solution selection; and
deploying a solution that is one of the one or more selected solutions based on the indication of solution selection to one or more computing devices.

14. The system of claim 11, wherein the alert includes one or more metrics associated with the one or more objects, wherein at least one performance indicator of the one or more performance indicators is associated with at least one metrics of the one or more metrics.

15. The system of claim 14, wherein the filter uses the at least one metric of the one or more metrics.

16. The system of claim 14, wherein at least one metric of the one or more metrics is dynamically changeable.

17. The system of claim 10, wherein the identifying one or more possible solutions comprises generating at least one of the one or more possible solutions.

18. The system of claim 10, wherein the alert includes a set of alerts, wherein the operations further comprise:
filtering the set of alerts to a first subset of alerts and a second subset of alerts;
wherein the one or more possible solutions include a first set of possible solutions associated with the first subset of alerts and a second set of possible solutions associated with the second subset of alerts.

19. A method for solution proposals, the method comprising:
generating an alert, the alert associated with one or more objects;
identifying one or more possible solutions associated with the alert, the one or more possible solutions including one or more actions applicable to the one or more objects;
applying a filter to the one or more possible solutions to select one or more solutions from the one or more possible solutions;
determining one or more performance indicators, each performance indicator of the one or more performance indicators being associated with one selected solution of the one or more selected solutions; and
presenting the one or more selected solutions with the one or more performance indicators;
wherein the method is performed using one or more processors.

20. The method of claim 19, further comprising:
receiving an indication of solution selection; and
deploying a solution that is one of the one or more selected solutions based on the indication of solution selection to one or more computing devices.
